(19) United States
(12) Patent Application Publication
(10) Pub. No.: US 2014/0329593 A1
(43) Pub. Date: Nov. 6, 2014

(54) TEXT ENTRY USING GAME CONTROLLER

(71) Applicant: NVIDIA Corporation, (US)

(72) Inventor: Antons Davis AKKARAKARAN, Santa Clara, CA (US)

(73) Assignee: NVIDIA Corporation, Santa Clara, CA (US)

(21) Appl. No.: 13/888,166

(22) Filed: May 6, 2013

(51) Int. Cl. A63F 13/20

(52) U.S. Cl. CPC A63F 13/06
USPC 463/31

(57) ABSTRACT

Method and system for efficient character entry using a game controller. A computer implemented method allows a user to select any character in a subsection of a virtual input array by interacting with a single physical key on the game controller. Characters in a subsection of the virtual input array are arranged in a pattern. The number of keystrokes for selecting a particular character corresponds to the position of the particular character with reference to the pattern of the subsection.

### TECHNICAL FIELD

The present disclosure relates generally to the field of input device, and more specifically to the field of character entry using controller device.

### BACKGROUND

Computer games continue to gain popularity among people of all ages. With advanced development of hardware, software and network technologies, electronic game devices, including personal computers, video game consoles, and handheld game consoles, have become increasingly versatile and powerful. Game playing has expanded from executing application programs stored on local storage mediums to synchronizing gaming systems with other players via network servers.

Modern game controllers are usually designed to be handheld by a user and integrate only a limited number of keys, the primary functions of which are controlling the movement/actions of a playable body/object or otherwise influence the events in a video or computer game. This makes it difficult to fit in a full size keyboard on the game controller. For example, a typical game controller may include a joystick on the left hand handle, four action keys on the right hand handle, and several action keys in the middle or the shoulder of the game controller.

With the expanded functionalities of an associated game console, a game controller is used not only for controlling the motions of the objects in the game, but also for inputting alphanumeric characters. For example, game players usually use game controllers to provide input to register for games, customize characters or other aspects of the game, interact with the game, and communicate with other game controllers, and even general computer programs like web browsers, email, online chat, etc. Such input may require alphanumeric characters.

The general solution is to implement an on-screen virtual keyboard which can be controlled by the limited number inputs on the game controller. FIG. 1A illustrates an on-screen graphic user interface (GUI) 110 of a virtual keyboard in accordance with the conventional art. The characters in the virtual keyboard are arranged in an alphabetic order. A user needs to visually identify a desired character, then direct the cursor, such as using a joystick or a designated button (as in the illustrated example), across the whole keyboard image until the desired character is highlighted by the cursor. The user then presses a selection key on the game controller to commit the selected character. Moving just one character per user interaction is timing consuming, which can be significant when a long phrase is entered. Users often find the process, especially when typing a long phrase, cumbersome and inconvenient.

FIG. 1B illustrates an on-screen GUI 120 having a virtual keyboard 120 in accordance with another example of conventional art. The characters are divided into groups 121, each group having four characters and mapped to the four action keys on the game controller, e.g. “A,” “B,” “X,” and “Y.” The characters in each section are arranged in the same patterns as the four actions keys. A user can select a group first by moving the cursor to the group and then select a character by pressing the action key corresponding to the character displayed in the group. As illustrated, to type “b,” a user can move the analog stick 122 to the top left group “abcd” and press the “X” button 124. To type “u” next, the user has to hold the analog stick 122 to the left and move down by two motions to select the bottom left group 121B, and then press the “Y” button 123 on the controller to select “u.” To select a character from a group, the user has to mentally associate the character with the corresponding physical button on the game controller, and moves his or her thumb to the right physical button.

FIG. 1C illustrates on-screen graphic user interface (GUI) 130 of a virtual keyboard 131 in accordance with a third example of the conventional art. Similar with the example in FIG. 1B, the characters in the virtual keyboard 131 are grouped together but as 8 groups around the analog stick. Thus pointing the analog stick to any of the 8 positions will trigger selection of a group. Once the group is selected, without releasing the analog stick, choose the character by hitting any of the 4 action keys (similar to FIG. 1B). Releasing the analog stick will return the analog stick to the center position and de-select any group. This makes selecting groups faster than FIG. 1B example but the difficulty in mapping virtual to physical characters still exists.

### SUMMARY OF THE INVENTION

Therefore, it would be advantageous to provide a character input mechanism that improves efficiency for a user to input characters using a game controller.

Accordingly, embodiments of the present disclosure provide a computer implemented method to facilitate a user locating and entering an intended character from a virtual input array using an input device. Embodiments of the present disclosure allow a user to select any character in a subsection of the virtual input array by interacting with a single physical key on an input device, advantageously providing a simplified and intuitive method of character entry. Characters in a subsection are arranged in a pattern. The number of keystrokes for selecting a particular character corresponds to the position of the particular character with reference to the pattern of the subsection.

In one embodiment of present disclosure, a computer implemented method of entering characters comprises rendering an on-screen graphic user interface (GUI) on a display device. The GUI comprises a first virtual keyboard and a text display area. The first virtual keyboard comprises a first plurality of sections, each containing a respective plurality of character arranged in a pattern. The method further comprises: (1) selecting a first section from the first plurality of sections in response to a first user instruction sent from a cursor directing component of an input device; (2) selecting a first character from the first section in response to a number of user interactions with a selection button of the input device, wherein the number corresponds to a position of the first character with reference to the pattern; and (3) presenting the first character in the text display area. In accordance with an embodiment, the input device may be a game controller and the cursor directing component may be a joystick. The input device may comprise a number of other physical buttons designated with editing functions. The GUI may comprise a second virtual keyboard arrange in a different pattern than the first virtual keyboard.

In another embodiment of the present disclosure, a method of accepting user input on a game system is described and comprising: (1) displaying a first input table and a text entry area, wherein the first input table comprises a first plurality of sets of characters arranged in a pattern; and (2) identifying a first character from the first plurality of sets of characters responsive to a combinational user interaction with a joystick and a selection key located on a game controller associated with the game system, wherein the joystick and the selection key are operable to coordinate to select any character in the first input table. The combinational user interaction may comprise a first part from a joystick to select a first set of characters, and a second part from the selection key to select the first character from the first set of characters. The first part may correspond to a user interaction moving the joystick to a direction associated with the first set of characters. The second part may correspond to a user using the selection key to a predetermined number of times corresponding to location of the first character. The first plurality of sets of characters may comprise alphabetic characters arranged in an alphabetic order.

In another embodiment of the present disclosure, an electronic game system is described and comprises: a processor coupled to a display and an input device via a communication channel; an Input/Output (I/O) interface configured to receive user instructions sent from the input device; a memory coupled with the communication channel. The memory is operable to store instructions that, when executed, implement a graphic user interaction (GUI) comprising a virtual keyboard and a text display area, wherein the virtual keyboard comprises a plurality of sections. Each section comprises a respective set of characters arranged in a pattern. The GUI is further configured to: (1) select a first section of the plurality of sections in response to a first user interaction sent from a cursor directing component of the input device; (2) select a first character from the first section in response to a number of user interactions with a selection button of the input device, wherein the number corresponds to a position of the first character with reference to the first section; and (3) present the first character in the text display area.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1A illustrates an on-screen graphic user interface (GUI) of a virtual keyboard in accordance with the conventional art.

FIG. 1B illustrates an on-screen GUI of a virtual keyboard in accordance with the conventional art.

FIG. 1C illustrates on-screen GUI of a virtual keyboard in accordance with a third example of the conventional art.

FIG. 2A illustrates an exemplary configuration of an on-screen GUI that facilitates character entry by a game controller in accordance with an embodiment of the present disclosure.

FIG. 2B illustrates a state of the GUI in which the section “abc” is selected and highlighted in accordance with an embodiment of the present disclosure.

FIG. 2C illustrates a state of the GUI in which the letter “a” is displays in the text entry area upon “A” button being pressed the first time in accordance with an embodiment of the present disclosure.

FIG. 2D illustrates a state of the GUI 200 in which the letter “b” is displays in the text entry area upon “A” button being pressed the second time within a short interval in accordance with an embodiment of the present disclosure.

FIG. 2E illustrates a state of the GUI when the section “mno” is highlighted (e.g., using a cursor directing device) and the character “o” is selected upon the “A” button being pressed three times consecutively in accordance with an embodiment of the present disclosure.

FIG. 3A illustrates an on-screen GUI including a default virtual keyboard of lower case alphabet characters being displayed as a default.

FIG. 3B illustrates that the on-screen GUI including a virtual keyboard including upper case alphabet characters is displayed in response to a first user interaction with the shift button.

FIG. 3C illustrates that the on-screen GUI including a virtual keyboard including symbolic and numeric characters are displayed in response to a second user interaction with the shift button.

FIG. 4 illustrates a virtual keyboard in which a respective character within a section corresponds to predetermined numbers of keystrokes in accordance with an embodiment of the present disclosure.

FIG. 5 is a flow chart depicting an exemplary computer controlled method of entering characters using a game controller in according with an embodiment of the present disclosure.

FIG. 6 illustrates an exemplary game system capable of receiving character input from a user in accordance with an embodiment of the present disclosure.

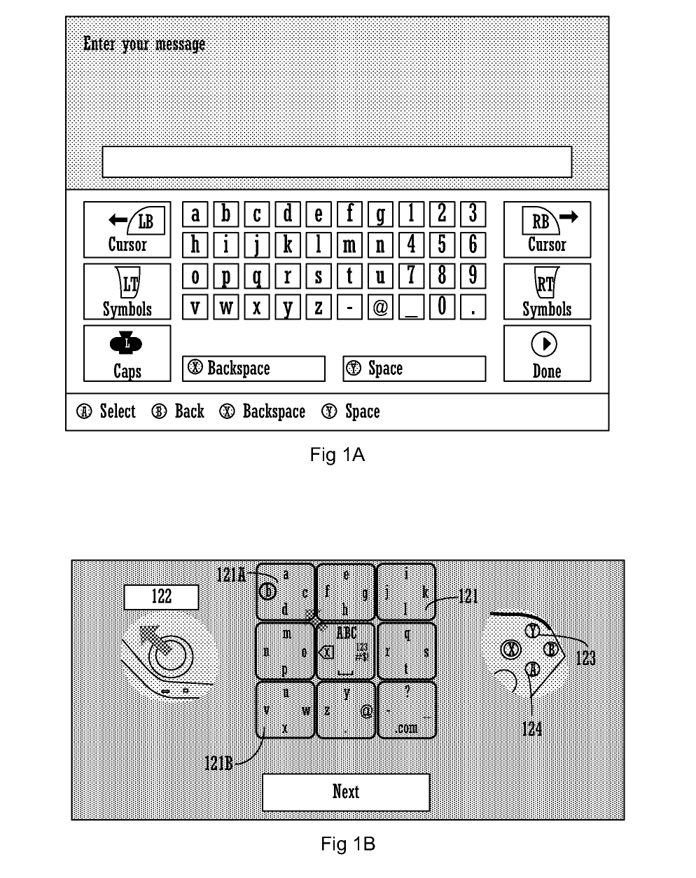

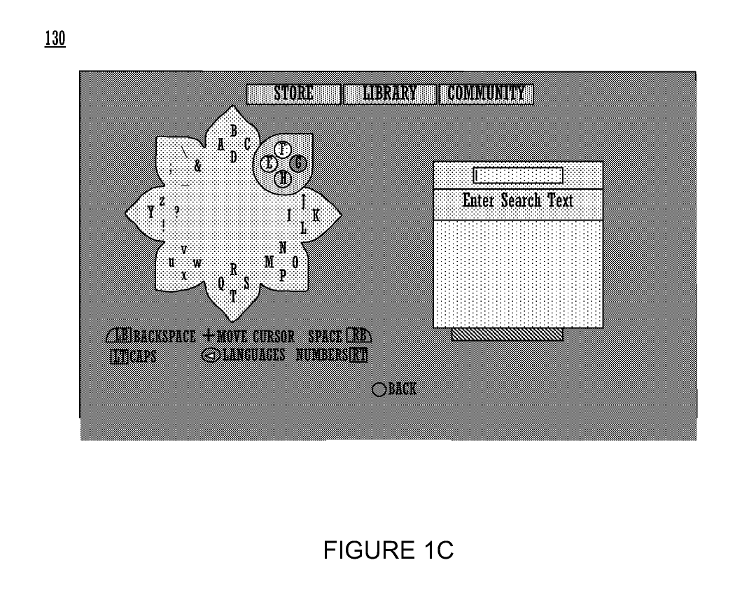

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Text Entry Using Game Controller

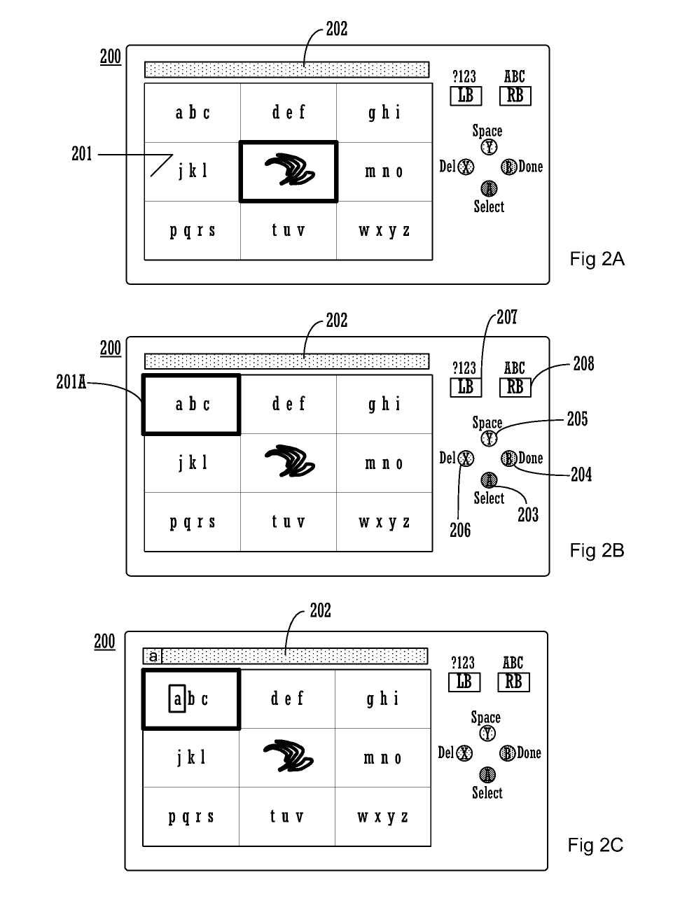

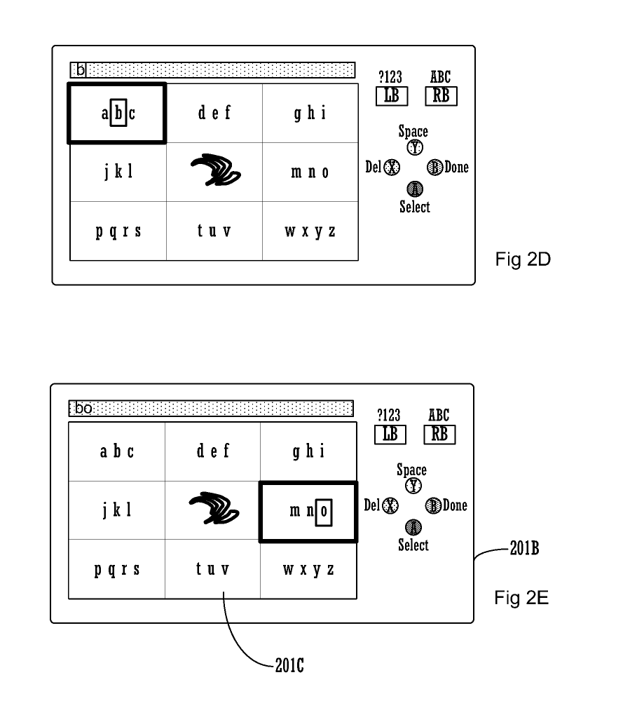

FIG. 2A illustrates an exemplary configuration of an on-screen graphic user interface (GUI) 200 that facilitates character entry by a game controller in accordance with an embodiment of the present disclosure. The GUI 200 comprises a virtual keyboard 201 and a text entry area 202. Optionally, as in the illustrated embodiment, an image of an associated input device 203 is displayed to explain the respective character entry functions assigned to each button.

In the illustrated GUI embodiment, the virtual keyboard 201 comprises 26 lower case alphabet letters which are divided into a number of sections, or groups, shown as tiles and arranged in an alphabetic order. A section can be populated with three or four letters, or any other number of characters in some other embodiments. The optional input device image 203 shows images of physical buttons on the input device accompanied by descriptions of their assigned input functions. In this embodiment, the “A” button on the game controller is configured as the selection button.

Through the GUI 200, the user is allowed to cycle through the characters in the section by pressing the same selection button repeatedly until the desired character displays in the text entry area. For example, to select a character “b,” a user first visually identifies and selects the displayed section that contains the desired character, namely the “abc” section. Then each time the user taps, or presses, the selection button, which is the “A” button 203 in the input device, a corresponding character displays in the data entry box 202. FIG. 2B illustrates the state of the GUI 200 in which the section “abc” is selected (e.g., using a cursor directing device) and highlighted in accordance with an embodiment of the present disclosure. FIG. 2C illustrates the state of the GUI 200 in which the letter “a” is displayed in the text entry area 202 upon “A” button being pressed the first time in accordance with an embodiment of the present disclosure. FIG. 2D illustrates the state of the GUI 200 in which the letter “b” is displayed in the text entry area 202 upon “A” button being pressed the second time within a short interval in accordance with an embodiment of the present disclosure. Once “b” is committed, the user can repeat the forgoing steps to select another character. FIG. 2E illustrates a state of the GUI 200 when the section “mno” 201B highlighted (e.g., using a cursor directing device) and the character “o” is selected upon the “A” button being pressed three times consecutively in accordance with an embodiment of the present disclosure. Thus, the character displayed in the text entry area 202 corresponds to the number of keystrokes applied on the single “A” button.

Therefore, the GUI 200 allows a user to select a character from an identified section by tapping the same physical button consecutively for a number of times that corresponds to the character's position in the section. This advantageously eliminates the mental mapping process for associating a desired character within a section to the corresponding physical button, and thereby provides a simplified and straightforward method of character entry. Further, the virtual keyboard can have an arrangement independent of the physical key arrangement, which offers the potential to populate any number of characters in the virtual keyboard and its sections.

Typically, the “A” button is more frequently used during game playing than the other actions buttons, e.g. “B,” “A,” and “Y,” so using the “A” button as the input selection button may be relatively intuitive to users. However, in other embodiments, any other physical key on the in the input device can be designated as the selection button. Since one action key suffices to select any character, other action keys can be assigned with other commonly used functions. For example, the “B,” “A,” and “Y can be used as shortcut keys for frequent edits such as “done′, “delete” and ‘space,” respectively, as illustrated in FIG. 2A-2E.

In still some other embodiments, for example where the input device comprises two analog devices or where a direction pad was used for section selection, an analog input device may be used as the selection key. By the same token, the position of a character in a particular section can correspond to a number of user interactions with the analog selection key.

A display section may be selected by a variety of means according to different embodiments, for example, by moving a joystick, or by pressing a direction pad on the input device. The plurality of sections in the virtual keyboard 200 are arranged in a three by three grid or array. Nonetheless, the present disclosure is not limited to any type of particular pattern of arrangement of the sections and characters, e.g., n×m, or n×n, etc. For example, in some embodiments, the sections can be arranged in a circle while the characters in each section can be arranged in a partial QWERTY format that is well known by ordinary users.

Referring back to FIG. 2A. The virtual keyboard 201 also comprises a spare section 210C with no input characters therein. For example, the GUI 200 may enter a predetermined default state, where the center section is selected, whenever the joystick is released. The spare section can be used to display an image of a trademark, or alike. In some other embodiments, the default section can be used to display a list of frequently used strings of characters, such as names of game characters, common phrases, recently entered phrases, and/or user-defined words, etc. The user can then use the selection button “A” as discussed above to navigate through the frequently used strings without going through the individual character selection process. The number of keystrokes to select a string may correspond to a position of the string within the list.

In some embodiments, the character entry GUI is capable of auto completion and auto correction based on the entered characters in the text entry area. The predicated phrase list for auto completion and/auto correction may be selected from a dictionary that is preloaded in the game system, or a dictionary accessible through network, or a library storing previously entered phrases with respect to a user or a game, etc. In turn, a committed phrase can be stored for future use.

A selected character can be committed as an entry through a variety of user interaction methods. For example, a user may release the joystick, press a designated physical button, move the cursor to an adjacent group, or simply pause for at least a predetermined length of time.

A character entry GUI according to the present disclosure may be configured to comprise a plurality of virtual keyboards of different character sets. According to the illustrated embodiment in FIG. 2A-2E, the “LB” button 207 on the input device is correlated to a keyboard GUI comprising numeric and punctuation characters, as suggested by the description “?123;” while the “RB” button 208 is correlated to a keyboard GUI comprising upper case alphabetic letters, as suggested by the description “ABC.” For example, in operation, in response to the user selecting the “RB” button 208, all characters in the on-screen displays of FIG. 2A-FIG. 2E become upper case. As will be appreciated by a person with ordinary skills of the art, any other type of mapping configuration correlating the physical keys to the virtual keyboards can be used to practice the present disclosure.

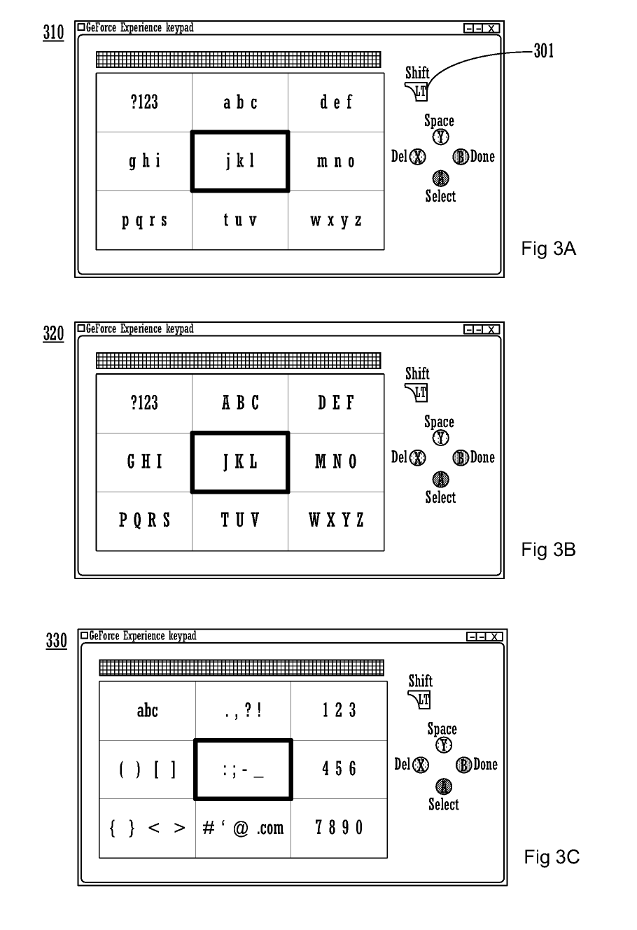

In some embodiments, a different virtual keyboard may be presented to a user upon a designated physical key being pressed, e.g. the “LT” button of the input device. FIG. 3A illustrates an on-screen GUI 300 comprising a default virtual keyboard 310 including lower case alphabet characters. FIG. 3B illustrates that the GUI 300 including a second virtual keyboard 320 including upper case alphabet characters is displayed in response to a first user interaction with the shift button. According to the illustrated embodiment, releasing the shift button would revert the user interface to the lower case keyboard as show in FIG. 3A. When a user navigates to the upper left group (“?123”) and press the A button, a numeric character/symbol virtual keyboard can be displayed as shown in FIG. 3C. In FIG. 3C, since the upper left group corresponds to a lower case virtual keyboard, as indicated by “abc,” the user can select this group to go back to alphabets. In some embodiments, pressing the “LT” shift button on the numeric character/symbols virtual keyboard can be used to bring up an advance symbols/characters keyboard. Thus, by repeatedly selecting the upper left group, a user can navigate through a series of virtual keyboards having, e.g. lower case alphabet, upper case alphabet, numbers/symbols and advanced symbols respectively.

Because characters' positions in its section are correlated to the numbers of keystrokes applied on a single selection button and thereby independent of the physical button layout on the game controller, in some embodiments, a section may comprise hidden characters that are only presented to a user when the section is selected. Thus, a virtual keyboard is capable of containing any number of characters and is free of limitations related to virtual keyboard size, such as a virtual keyboard of foreign language characters.

In some embodiments, a section may comprise any number of additional related characters that only appear on the virtual keyboard when the section is selected, and otherwise remain hidden. A user can identify the section that contains the desired character based on a mental association between the display characters with the hidden characters. In this manner, a virtual keyboard is capable of containing any number of characters and is free of limitations related to the sizes of the virtual keyboard. For example, the GUI may comprise a virtual keyboard having foreign language characters, e.g. Chinese and Japanese.

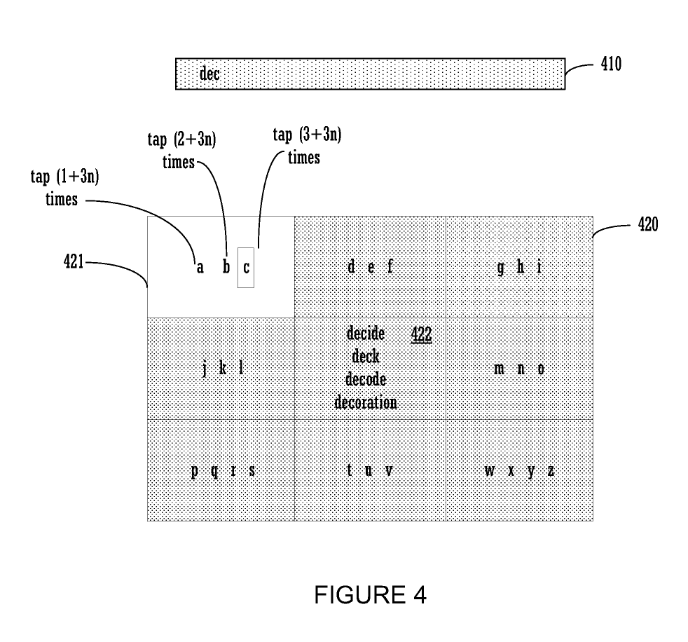

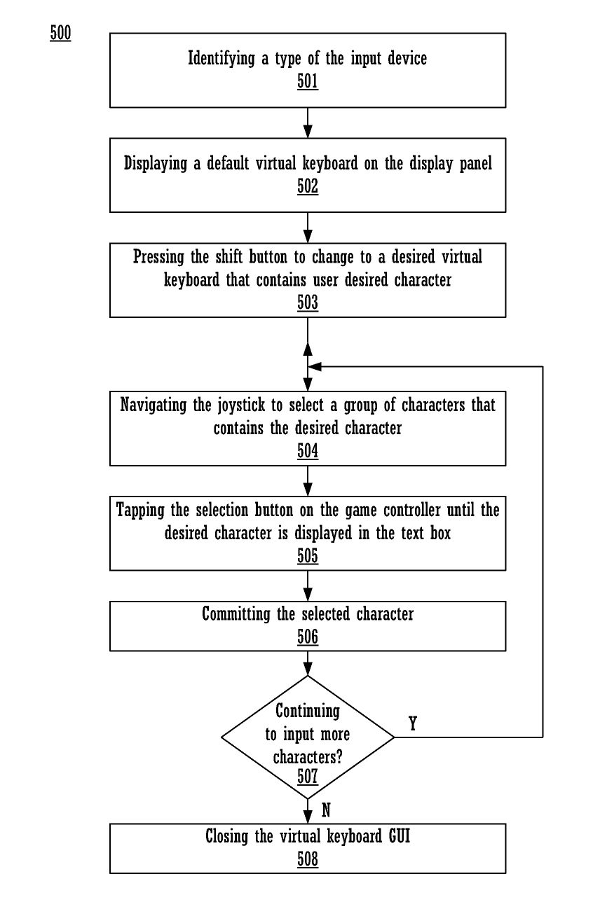

FIG. 4 illustrates a virtual keyboard 420 in which a respective character within a section corresponds to predetermined numbers of keystrokes in accordance with an embodiment of the present disclosure. For example, the first section 412 includes three characters “a” “b” and “c.” When the first section 412 is selected, the character to be displayed in the text entry area 410 is determined by the number that a user taps the selection key. In this example, the first character “a” is selected when the user taps the selection key for (1+3n) times, where n=0, 1, 2, 3, . . . . “b” and “c” corresponds to (2+3n) and (3+3n) tapping actions, respectively.

In the illustrated example, the center section 422 displays a list of suggested phrases in response to the entered strings of characters: “dec.” Similarly, to select from the suggested phases, the user can direct a cursor to select the center section 422 and then tap the selection key a certain number of times corresponding the its position on the list to select the desired phase.

FIG. 5 is a flow chart illustrating an exemplary method 500 of entering characters using an electronic controller in accordance with an embodiment of the present disclosure. At 501, a game console first identifies a type of the game controller being used. At 502, a default virtual keyboard that is specific to a game controller in connection is presented on the display panel. At 503, the user can press the shift button and request to shift to another virtual keyboard that encompasses a desired character. At 504, the user can use the cursor directing device, e.g. a joystick, to select a group of characters that contains the desired character. The user then tap the selection button consecutively until the desired character displays in the text entry box, at 505. The number of taps required corresponds to the position of the desired character in the selected group. At 506, a character commit operation then selects the displayed character. The character commit operation can be as simple as the user waiting for a predetermined amount of time, pressing a special input button, moving to an adjacent group, or releasing the cursor directing device. The user repeats the steps of 503-506 until he or she decides to terminate the text entry process at 507 and closes the virtual keyboard GUI at 508.

The character entry method in accordance with the present disclosure can be implemented as a computer program stored in a computer readable mediums, e.g. magnetic storage devices, optical disks, smart cards, and flash memory devices, and executable by a suitable processor.

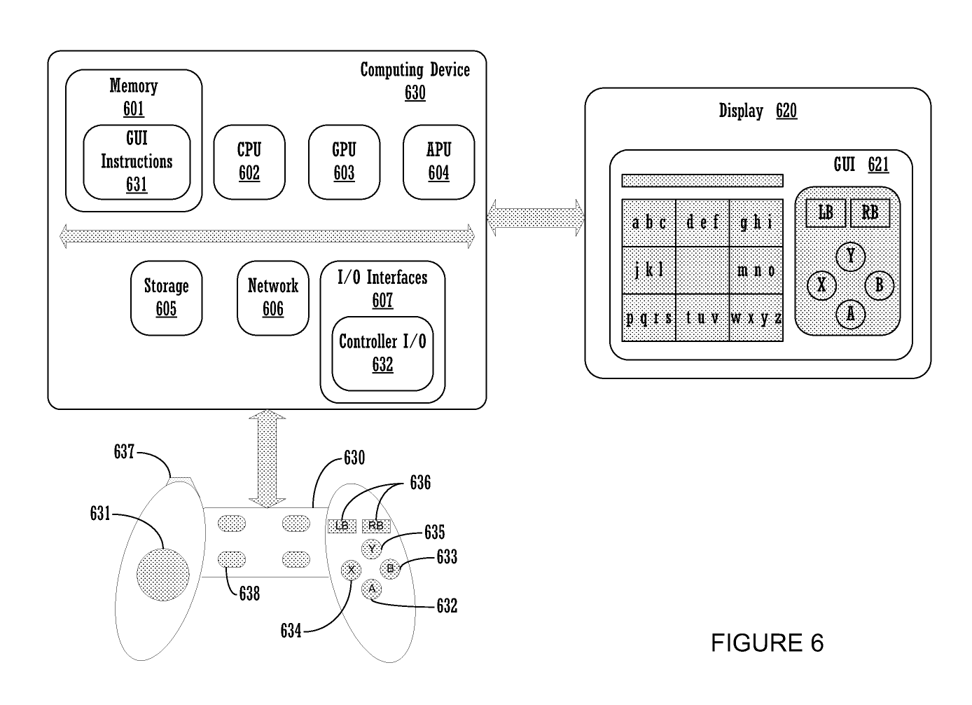

The character entry method in accordance with the present disclosure can be carried out in conjunction with any type of game console and game input device. FIG. 6 illustrates an exemplary game system 600 capable of receiving character input from a user in accordance with an embodiment of the present disclosure. The game system 600 comprises a computing device 610, a display panel 620, and a game controller 630. The three components can be separate units from each other. Alternatively, any two or all three of them can be an integrated unit. For example, the game controller may be equipped with a display panel, or the game system may be a game pad having all three components in one unit. A separate game computing device 610 can be either locally connected to the display panel 620 and the game controller 630, or through communication network, such as a local area network (LAN) or Internet. Thus, the game system 600 may be a desktop, laptop, a remote compute, a server, a game console, a mobile computing device, a game pad, and so on. The computing device 610 may operate in a networked environment capable of connect to a remote computer, e.g. a workstation, a server, a personal computer, a network PC, a mobile computing device, a cloud computing device, a peer device, and the like.

In the illustrated embodiment, the computing device 610 comprises a central processing unit 602, a graphic processing unit 603, an audio processing unit 604, a memory 601, an external storage device 605, a network circuit 606, and I/O interfaces 607.

The memory 601 stores GUI instructions 611, which is presented to the user on the display 620 as the GUI 621, operable to perform a character entry method in accordance with an embodiment of the present disclosure. The GUI instructions 611 may be executed in part or in whole by at least one suitable processing unit, e.g. 602, 603, and 604. The GUI instructions 611 may be embedded in a game program or independent of any game program.

In some embodiments, the computing device 610 can provide computing, communication, media play back as well as game playing capability. The computing device 610 can also include other components (not explicitly shown) to provide various enhanced capabilities, e.g. a phone circuit and a power management unit.

The processors e.g. 602, 603, and 604, can be implemented as one or more integrated circuits and can control the operation of computing device 610. In some embodiments, the CPU 602 can execute a variety of operating systems and software programs and can maintain multiple concurrently executing programs or processes. The storage device 605 can store user data and application programs to be executed by the CPU 602, such as a character entry program in accordance with an embodiment of the present disclosure, video game programs, personal information data, media play back program. The storage device 605 can be implemented using disk, flash memory, or any other non-volatile storage medium.

Network or communication interface 606 can provide voice, data communication, and/or game distributing capability for the computing devices 610. In some embodiments, network interface can include radio frequency (RF) transceiver components for accessing wireless voice and/or data networks or other mobile communication technologies, GPS receiver components, or combination thereof. In some embodiments, network interface 606 can provide wired network connectivity instead of or in addition to a wireless interface. Network interface 606 can be implemented using a combination of hardware, e.g. antennas, modulators/demodulators, encoders/decoders, and other analog/digital signal processing circuits, and software components.

I/O interfaces 607 provide communication and control between the computing device 610 with other external I/O devices, e.g. the game controller 630, another computer, a body motion sensor, an external speaker dock or media playback station, a digital camera, a separate display device, a card reader, a disc drive, in-car entertainment system, an external storage device, user input devices or the like.

The game controller 630 may be any type of game input device, for instance, a keyboard, a paddle, a touch screen, a gamepad, and a handheld game controller. In the illustrated embodiment, the game controller 630 comprises a joystick, actions buttons 632, 633, 634 and 635, “LB” button and “RB” button 636, a shoulder trigger button 637, and other buttons 638. The game controller may also comprise one or more of a mouse, a steering wheel, a direction pad, light gun, trackball, a paddle, a throttle quadrant, a yoke, a pedal, and so forth.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of entering characters, said method comprising rendering a graphic user interface (GUI) on a display device wherein said GUI comprises a first virtual keyboard and a text display area, wherein said first virtual keyboard comprises a first plurality of sections, each section comprising a respective plurality of characters arranged in a pattern;
selecting a first section from said first plurality of sections in response to a first user instruction sent from a cursor directing component of an input device;
selecting a first character from said first section in response to a number of user interactions with a selection button of said input device, and wherein further said number corresponds to a position of said first character with reference to said pattern; and
presenting said first character in said text display area.

2. The method of claim 1,
wherein said input device is a game controller;
wherein said cursor directing component is a joy stick;
wherein said selection button is an action button; and
wherein said input device comprises a plurality of action buttons disposed proximate to said selection button; and
further comprising: deleting a character from said text display area; backspacing a character from said text display area; and presenting a character space in said text display area, in response to user interactions with said plurality of action buttons, respectively.

3. The method of claim 1, wherein said first plurality of sections are arranged in a n by m grid, wherein n and m are integers.

4. The method of claim 3 further comprising presenting: suggested strings of characters in one of said first plurality of sections, wherein said suggested strings of characters are frequently used strings of characters; and selecting a string from said strings in response to a number of user interactions with said selection button, wherein said number corresponds to a position of said string.

5. The method of claim 3, wherein said first virtual keyboard comprises alphabetic characters arranged in an alphabetic order, and wherein further a respective section in said first virtual keyboard comprises more than four characters.

6. The method of claim 1 further comprising presenting a second virtual keyboard in response to a user interaction on a shift button on said input device, wherein said second virtual keyboard comprises a second plurality of sections, each section comprising respective characters selected from a group consisting of numeric characters, symbols, phrases, user defined words, foreign language characters, lower case characters, and upper case characters.

7. The method of claim 6, wherein said second plurality of sections are arranged in a different pattern from said first plurality of sections.

8. The method of claim 1 further comprising committing said first character in response to a user interaction selected from a group consisting of releasing said cursor directing component, pressing a designated button on said game controller, moving an on-screen cursor to an adjacent section, and pausing for at least a predetermined time before sending a subsequent user interaction.

9. The method of claim 1 further comprising repeating a last entry in response to a user interaction with a designated button on said input device.

10. The method of claim 1 further comprising: predicting an intended string of characters based on entered characters in said text display area; and committing said intended string of characters in response to a user instruction.

11. The method of claim 1, wherein the selecting said first section comprises visually highlighting said first section, and wherein the selecting said first character comprises: presenting additional characters; and highlighting said first character.

12. A method of accepting user input on a game system, said method comprising:
displaying a first input table and a text entry area, wherein said first input table comprises a first plurality of sets of characters arranged in a pattern; and
identifying a first character from said first plurality of sets of characters responsive to a combinational user interaction with a joystick and a selection key located on a game controller associated with said game system, wherein said joystick and said selection key are operable to coordinate to select any character in said first input table.

13. The method of claim 12, wherein said combinational user interaction comprises a first part from said joystick to select a first set of characters that comprises said first character, and a second part from said selection key to select said first character from said first set of characters based on a location of said first character in relation to said pattern.

14. The method of claim 13, wherein said first plurality of sets of characters comprise alphabetic characters, wherein further each set of said first plurality of sets of characters are arranged in an alphabetic order, and wherein said first part corresponds to a user interaction with said joystick to a direction associated with said first set of characters, and said second part corresponds to a user pressing said selection key a predetermined number of times corresponding to a location of said first character with respect to said pattern.

15. The method of claim 12 further comprising displaying a different input table in response to a user interaction with a shift button on said game controller, said different input table comprising a different plurality of sets of characters selected from a group consisting of numbers, symbols, foreign characters, user defined words, phrases, and upper chases letters.

16. An electronic game system comprising
a processor coupled to a display and an input device via a communication channel;
an Input/Output (I/O) interface configured to receive user instructions sent from said input device;
a memory coupled with said communication channel, said memory operable to store instructions that, when executed, implement a graphic user interaction (GUI) comprising a virtual keyboard and a text display area, wherein said virtual keyboard comprises a plurality of sections, each section comprising a respective set of characters arranged in a pattern, said GUI further configured to:
select a first section of said plurality of sections in response to a first user interaction with a cursor directing component of said input device;
select a first character from said first section in response to a number of user interactions with a selection button of said input device, and wherein further said number corresponds to a position of said first character with reference to said first section; and
present said first character in said text display area.

17. The electronic game system of claim 16, wherein said display and said input device are coupled with said processor through a network, and wherein said input device comprises a touchscreen panel.

18. The electronic game system of claim 16, wherein said input device is selected from a group consisting of a game controller, a keyboard, a portable computing device, a smartphone, a control panel, wherein said cursor directing component comprises a joystick, wherein said input device comprises a plurality of buttons comprising said selection button, a delete button, a space button, a backspace button, and a shift button, wherein said joystick and said selection button are configured to coordinate to select any character on said virtual keyboard.

19. The electronic game system of claim 17, wherein said shift button, when pressed, is configured to send an instruction to said video game system to change to a different virtual keyboard.

20. The electronic game system of claim 20, wherein said GUI is further configured to predict an intended string of characters based on an incomplete entry of characters.
